(19) United States
(12) Patent Application Publication
(10) Pub. No.: US 2006/0290261 A1
(43) Pub. Date: Dec. 28, 2006

(54) Bonding material

(76) Inventors: Yuichi Sawai, Mito (JP); Takashi Naito, Funabashi (JP); Osamu Shiono, Hitachi (JP); Motoyuki Miyata, Hitachinaka (JP); Hiroyuki Akata, Hitachi (JP); Keiichi Kanazawa, Ome (JP); Yuuichi Kijima, Chosei (JP); Shigemi Hirasawa, Chiba (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/453,024

(22) Filed: Jun. 15, 2006

(30) Foreign Application Priority Data
Jun. 17, 2005 (JP) 2005-178260
Jun. 17, 2005 (JP) 2005-178274
Jul. 15, 2005 (JP) 2005-207696

(51) Int. Cl. H01J 1/62; H01J 63/04

(52) U.S. Cl. 313/495; 313/292

(57) ABSTRACT

It is an object to provide an electric conductive, Pb-free bonding material for securing spacers for display panels of display devices.

The electric conductive bonding material as the first aspect of the present invention contains a V₂O₅-based glass as a main component, and particles of a metal selected from the group consisting of Pt, Pd, Cr, Ni, Al, Si, Zn, Au and Fe—Ni alloy, or of one or more species of electric conductive ceramics which can be selected from the group consisting of TiC, SiC, WC, ZnO, Fe₂O₃, FeO, Fe₃O₄, AgV₇O₁₈ and Ag₂V₄O₁₁ at 10 to 50% by volume.

The electric conductive bonding material as the second aspect of the present invention contains V₂O₅ at 55 to 75%, P₂O₅ at 15 to 30%, BaO at 0 to 25% Sb₂O₃ at 0 to 15% (total content of BaO and Sb₂O₃ adjusted at 5% or more), and GeO₂ at 5 to 20% or Ag₂O at 3 to 10%, all percentages by mass.

### FIELD OF THE INVENTION

The present invention relates to an electric conductive bonding material and a display device. The display device is suitable for a self luminous, flat panel type which utilizes emission of electrons into a vacuum, in particular suitable for an apparatus equipped with a display panel comprising a rear panel and front panel, where the rear panel is composed of a rear substrate having electron sources which emit electrons by field emission, and the front panel is composed of a front substrate having fluorescent layers each being excited by electrons from the rear panel to emit a different color and positive electrodes working as electron accelerator electrodes, with spacers arranged to keep a given gap between the rear and front panels (the spacer may be hereinafter referred to as gap-keeping member or partition).

### BACKGROUND OF THE INVENTION

Color cathode-ray tubes have been widely used for high-luminance, high-fineness display devices. Recently, however, demands for displays which have high-luminance, high-fineness characteristics and, at the same time, flat shapes are increasing for their light, space-saving characteristics as information processing and telecasting devices are required to produce higher-quality images.

Liquid crystal and plasma display devices have been commercialized as typical examples of the flat devices. Moreover, various new types of flat display devices are being commercialized to produce higher-luminance images. These include devices emitting electrons or fields from an electron source into a vacuum, and organic EL displays characterized by their low power consumption. A plasma display, electron-emitting display and organic EL display which need no auxiliary illuminated light source are commonly referred to as self-luminous, flat image displays.

Of the self-luminous, flat image display, the known field emission devices include those having a cone-shape electron emission structure, invented by C. A. Spindt et al, a metal-insulator-metal (MIM) type electron emission structure, an electron emission structure which utilizes an electron emission phenomenon by quantum tunnel effect (sometimes referred to as surface-conduction electron source), and an electron emission structure which utilizes an electron emission phenomenon activated by a diamond or graphite membrane or nano-tubes (represented by carbon nano-tubes).

A display panel which constitutes an electron emission display as one example of self-luminous, flat image displays comprises a rear panel and front panel, where the rear panel is composed of a rear substrate having, in the inside, electrode lines with field emission electron sources (the line is commonly referred to as cathode, signal or data line, and hereinafter referred to as signal line) and electrode lines as control electrodes (the line is commonly referred to as gate or scanning line, and hereinafter referred to as scanning line), whereas the front panel is composed of a front substrate having, in the inside, fluorescent layers each emitting a different color and accelerator electrodes (the electrode is referred to as positive electrode or positive electrode), the members in the rear substrate facing those in the front substrate. The front substrate which constitutes the front panel is made of an optically transparent material, for which glass is suitably used, whereas the rear substrate is made of a heat insulating material, for which glass, alumina or the like is suitably used.

The rear and front panels are bonded to each other via a sealing frame (commonly made of glass, and sometimes referred to as frame glass) extending along the inner circumferential edges, and sealed by a sealant to form a vacuum space surrounded by these panels and frame.

The electron sources are located at near the intersections of the signal and scanning lines, a potential difference between these lines being used to control amount of electrons emitted from the sources, including on-off control of emission. The emitted electrons are accelerated by a high voltage applied to the positive electrodes in the front panel to hit the fluorescent layers also in the front panel, to excite them to emit a color characteristic of each layer.

An individual electron line forms a unit picture cell together with a corresponding fluorescent layer. In general, a set of three unit cells each being responsible for red (R), green (G) or blue (B) color form a picture cell (referred to as color picture cell or pixel), where the unit cell is referred to as an auxiliary cell (sub-pixel).

A frame glass is secured to the rear and front panels along the inner circumferential edges via a sealant of frit glass or the like to keep the air-tight space, surrounded by these panels and frame, vacuum at 10⁻⁵ to 10⁻⁷ torr, for example. A display panel of large display plane uses a rear and front panels secured to each other with a bonding material via spacers arranged to keep a given gap between them. The spacer is a heat insulating, plate-shape member, e.g., of glass or ceramic, coated with a film having some electroconductivity, or of a plate-shape member having some electroconductivity. Generally, one spacer is arranged for a given number of pixels at a position where it causes no interference with pixel functions.

Various studies have been made on structures with spacers for keeping a rear and front panels spaced from each other by a given gap. The structures proposed so far include those devised to prevent distortion of an electron line orbit when the spacer is charged up, to prevent loss of its partition functions by suitably arranging the spacers, and to prevent discharge.

The bonding materials for arranging spacers include electric conductive frit of PbO-based glass, Bi₂O₃-based glass, SiO₂—Bi₂O₃-based glass, soda glass, silica glass and the like incorporated with at least one of Si, Zn, Al, Sn, Mg and the like, as disclosed by Patent Document 1. Moreover, Patent Document 2 discloses circuit-protecting glasses incorporated with at least one species selected from the group consisting of V₂O₅, ZnO, B₂O₃, SiO₂, Al₂O₃, MgO, CaO, SrO and BaO. Patent Document 3 discloses low-expansion glass incorporated with a fine, electric conductive powder, suitably of copper.
(Patent Document 1): JP-A-2001-338528
(Patent Document 2): JP-A-2-289445
(Patent Document 3): JP-A-61-281044

### BRIEF SUMMARY OF THE INVENTION

A spacer for a field emission display panel is prepared to be electric conductive to an extent to exhibit a resistivity of about 10⁸ to 10⁹ Ω·cm to prevent charge up. It needs a bonding material (of glass paste or frit glass) electric conductive to an extent to exhibit a resistivity of about 10³ to 10⁷ Ω·cm, to be secured to a rear and front panels, or to a rear substrate (normally of glass) and front substrate (also normally of glass) by the aid of the bonding material.

The bonding material is also required to have a thermal expansion coefficient sufficiently close to that of the glass material for the substrates, and wettability with them to be well bondable thereto at temperature lower than the highest temperature (about 450° C.) occurring in the production process.

A composite of PbO-based glass, known for its good bonding characteristics, incorporated with Ag or Au particles widely used as electric conductive metal particles, can be possibly used for the bonding material. However, it may have a high surface resistivity to make the surface insulating, even when it has a desired volumetric resistivity. Therefore, it should be incorporated with Ag or Au particles at a sufficient content to have a required electroconductivity (including surface conductivity), which, however, will greatly deteriorate frit wettability. Moreover, use of PbO-containing glass is banned in and after 2006 for environmental reasons, and development of substitutes is needed.

It is an object of the present invention to provide a novel, electric conductive bonding material for securing spacers to display panels. It is another object to provide a display with spacers secured with the aid of the bonding material.

Other objects, features and advantages of the invention will become apparent from the following description of the embodiments of the invention taken in conjunction with the accompanying drawings.

### BRIEF DESCRIPTION OF THE DRAWINGS

FIG. 1 illustrates one example of the display device of the present invention.

FIG. 2 is a cross-sectional view schematically illustrating the detailed structure of the display device along the line A-A′ shown in FIG. 1.

FIG. 3 is an enlarged cross-sectional view illustrating the essential portion of the display shown in FIG. 2.

FIG. 4 is an oblique view, partly cut to illustrate in more detail the whole structure of one embodiment of the display device of the present invention.

FIG. 5 is a cross-sectional view illustrating the display device along the line A-A′ shown in FIG. 4.

FIG. 6 schematically illustrates one example of pixel structure for the display device of the present invention.

FIG. 7 illustrates one example of equivalent circuits for the display device of the present invention.

### DESCRIPTION OF REFERENCE NUMERALS

| | |
|---|---|
| PNL1 | Rear panel |
| PNL2 | Front panel |
| SUB1 | Rear substrate |
| SUB2 | Front substrate |
| CL | Signal line |
| CLT | Signal line terminal |
| GL | Scanning line |
| GLT | Scanning line terminal |
| SPC | Spacer |
| PH | Fluorescent layer |
| BM | Black matrix |
| AD | Frame glass |
| MFL | Positive electrode |
| FGS | Electric conductive bonding material |
| FGM | Sealant |

### DETAILED DESCRIPTION OF THE INVENTION

The first aspect of the present invention for satisfying the above object is an electric conductive bonding material which is a composite mainly composed of a vanadium pentaoxide (V₂O₅)-based glass, i.e., glass containing V₂O₅ at 30 to 70%, P₂O₅ at 10 to 60%, BaO at 5 to 30% and Sb₂O₃ at 5 to 30%, all percentages by mass, and having a softening temperature of 250 to 360° C. The glass as the main component is highly wettable with a spacer for display panel and rear and front substrates which constitute the display panel, and is incorporated with fine electric conductive particles, in order to satisfy the object of the present invention. The fine electric conductive particles are preferably of a metal selected from the group consisting of Pt, Pd, Cr, Ni, Al, Si, Zn, Au and Fe—Ni alloy, or of one or more species of electric conductive ceramics selected from the group consisting of TiC, SiC, WC, ZnO, Fe₂O₃, FeO, Fe₃O₄, AgV₇O₁₈ and Ag₂V₄O₁₁. The metal or electric conductive ceramic particles are incorporated at 1 to 40% by volume, in order to simultaneously satisfy electric conductivity and wettability for the bonding material.

The second aspect of the present invention for satisfying the above object is an electric conductive bonding material containing a vanadium pentaoxide (V₂O₅)-based glass, highly wettable with a spacer for display panel and rear and front substrates which constitute the display panel, and having a low melting point. It has a composition to be more electric conductive. More specifically, it contains V₂O₅ at 55 to 75%, P₂O₅ at 15 to 30%, BaO at 0 to 25% and Sb₂O₃ at 0 to 15% (total content of BaO and Sb₂O₃ adjusted at 5% or more), and GeO₂ at 5 to 20% or Ag₂O at 3 to 10%, all percentages by mass as oxide.

The inventors of the present invention have noted an electric conductive V₂O₅—P₂O₅-based glass to realize the electric conductive bonding material as the second aspect of the present invention. The V₂O₅—P₂O₅-based glass is electric conductive. The inventors have extensively studied to have a composition of reduced electroresistivity of the V₂O₅—P₂O₅-based glass and adjusted characteristics with respect to thermal expansion and heat resistance needed for applying the V₂O₅—P₂O₅-based glass as an electric conductive bonding material.

Unlike the first aspect of the present invention, where glass as poor conductor is incorporated with electric conductive particles, the second aspect is intended to impart adequate electroconductivity, thermal expansion and temperature characteristics to the glass composition itself. A filler to be incorporated to finely adjust thermal expansion coefficient of the electric conductive bonding material of the present invention is not required to be electric conductive in itself. Therefore, it may be selected from widely varying ceramic materials of low thermal expansion coefficient, e.g., SiO₂, ZrO₂, Al₂O₃, ZrSiO₄, zirconium phosphate (ZWP), cordierite, mullite or eucryptite, and incorporated at 5 to 30% by volume. An electric conductive filler can be incorporated to make the composition more electric conductive.

Temperature at which the electric conductive bonding material is used can be adjustable in a range from 430 to 550° C. In this case, the bonding material composition is adjusted to resist a temperature of about 380 to 400° C. When required to be used at a lower temperature, the electric conductive bonding material is incorporated with Ag₂O at 3 to 10% in place of GeO₂ at 5 to 20%, all percentages by mass. Temperature at which the above material is used can be adjustable in a range from 380 to 450° C., and the bonding material composition is adjusted to resist a temperature of about 280 to 320° C. Bonding temperature is preferably lower, which, however, is accompanied by decreased heat resistance of the composition. Accordingly, the different composition can be selected depending on heat resistance which it is required to have.

The present invention provides a display device comprising a rear panel, front panel, spacers, and frame glass,

wherein the rear panel has a rear substrate which supports a display region composed of: a number of signal lines running in parallel to each other in a first direction; a number of scanning lines, insulated from the signal lines and running in parallel to each other in a second direction intersecting with the first direction; and a number of pixels having electron sources located at near intersections of the signal lines and the scanning lines,

the front panel has a front substrate which supports positive electrodes and fluorescent layers each being excited by electrons from the electron sources to emit a different color,

the spacers are bonded between the rear panel and the front panel in the display region with the aid of an electric conductive bonding material to keep a prescribed gap between the rear panel and the front panel, and

the frame glass is secured to the rear panel and the front panel along inner circumferential edges via a sealant to keep a space between them air-tight, wherein

the electric conductive bonding material is the one according to the first or second aspect.

The spacer preferably comprises a molding of a glass material containing SiO₂ as a main component and at least one element selected from the group consisting of La, Sc, Y, Ce, Pr, Nd, Pm, Sm, Eu, Gd, Tb, Dy, Ho, Er, Tm, Yb and Lu at 1 to 20% by mass (the glass material is hereinafter referred to as a rare-earth-containing glass).

### EXAMPLES

Embodiments of the present invention are described in detail by referring to the attached drawings.

It is to be understood that the present invention is not limited by the structures described above and those described hereinafter in the example, and needless to say that various variations can be made without departing from the technical concept of the present invention. In particular, the embodiments are described by taking, as an example, structures with an MIM electron source. However, a variety of electron sources described above, not limited to an MIM source, are applicable to the self-luminous display.

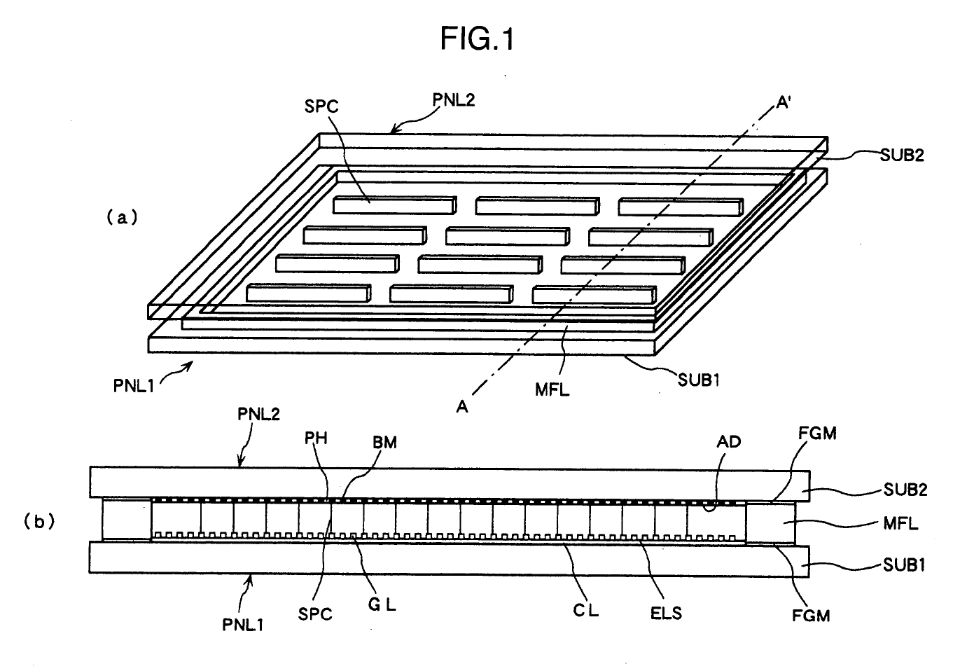

FIG. 1 illustrates one example of the display of the present invention, where (a) is an oblique view and (b) is a cross-sectional view along the line A-A′. In the display shown in FIG. 1, the rear substrate SUB 1 which constitutes the rear panel PNL 1 has the signal lines (data or cathode lines) CL and scanning lines (gate electrode lines) GL running inside, and electron sources ELS located at the intersections of these lines. Each of these lines is connected to an interconnection at the terminal (not shown).

The front substrate SUB 2 which constitutes the front panel PNL 2 has the light-shielding membrane (black matrix BM), positive electrodes (metalback or positive electrode) and fluorescent layers PH, among others. The rear substrate SUB 1, which constitutes the rear panel PNL 1, and the front substrate SUB 2, which constitutes the front panel PNL 2, are secured to each other via the sealing frame (frame glass) MFL extending along the inner circumferential edges, and sealed by the sealant FGM. The spacers described above are secured to these panels to keep a given gap between them by an electric conductive bonding material (not shown).

The inner space sealed by the rear substrate SUB 1, front substrate SUB 2 and sealing frame MFL is evacuated through a discharge nozzle (not shown) provided on the rear substrate SUB 1 to be kept at a given degree of vacuum. These structures are described later.

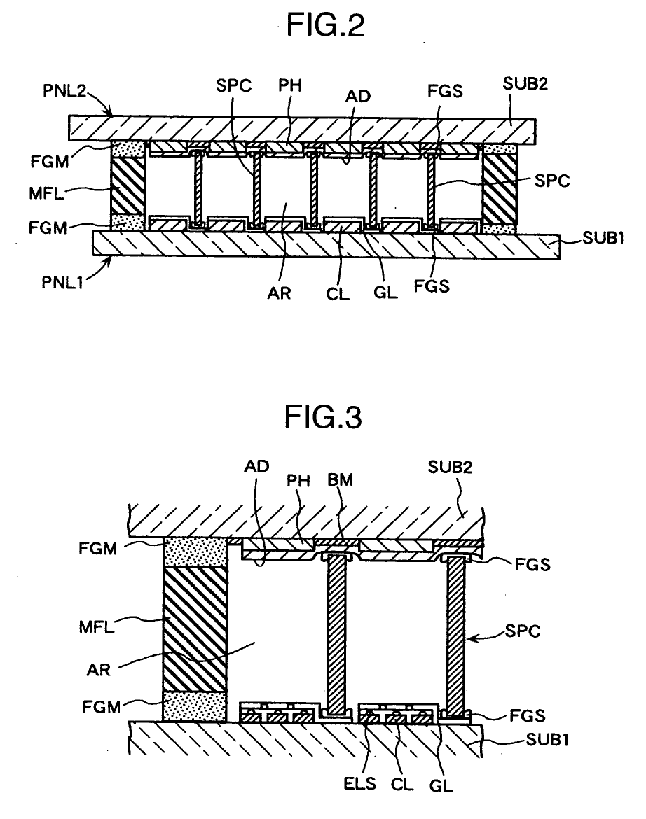

FIG. 2 is a cross-sectional view schematically illustrating the detailed structure of the display along the line A-A′ shown in FIG. 1, and FIG. 3 is an enlarged cross-sectional view illustrating the essential portion of the display shown in FIG. 2. In FIGS. 2 and 3, FGM stands for a sealant for securing the frame glass MFL, FGS for an electric conductive bonding material for securing the spacers, and AR for a display region. The member having the same function as that shown in FIG. 1 is marked with the same reference numeral (symbol).

In the above structure, the rear substrate SUB 1 has a plate shape, for which glass or ceramic material (e.g., alumina) is suitably used, and the front substrate SUB 2 also has a plate shape, for which glass is normally used. The front substrate SUB 2 has the black matrix BM, fluorescent layers PH and positive electrode AD described above in the inside.

The frame glass MFL, which is provided along the inner circumferential edges of the rear substrate SUB 1 and front substrate SUB 2 to also work as an outer frame, is secured to these substrates via the sealant FGM to keep a given gap (e.g., about 3 mm) between these substrate edges.

The spacers SPC are secured to the scanning lines GL provided on the inner surface of the rear substrate SUB 1 and to the positive electrodes AD on the black matrices BM provided on the inner surface of the front substrate SUB 2 by the electric conductive bonding material FGS.

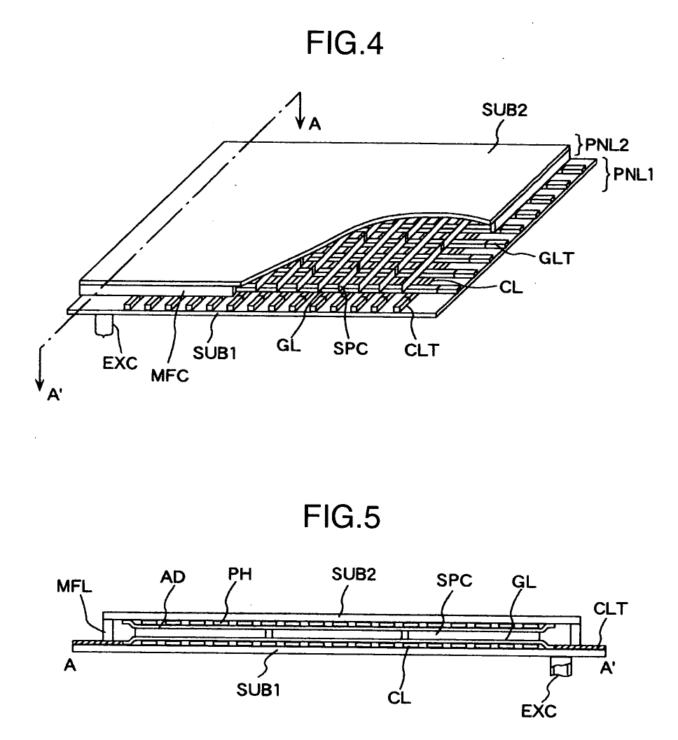

FIG. 4 is an oblique view, partly cut to illustrate in more detail the whole structure of one embodiment of the display of the present invention. FIG. 5 is a cross-sectional view illustrating the display along the line A-A′ shown in FIG. 4. To repeat the illustration, the substrate SUB 1 which constitutes the rear panel PNL 1 has, in the inside, the electrode lines CL, scanning lines GL and electron sources at near the intersections of these lines. Each of the electrode line CL and scanning line GL is connected to an interconnection at the terminal.

As described above, the front substrate SUB 2 which constitutes the front panel PNL 2 has, in the inside, the positive electrodes AD and fluorescent layers PH. The rear substrate SUB 1, which constitues the rear panel PNL 1, and the front substrate SUB 2, which constitutes the front panel PNL 2, are secured to each other via the sealing frame MFL extending along the inner circumferential edges. As described above, the spacers SPC, for which glass or ceramic plates are suitably used, are arranged between these substrates to keep a given gap between them. FIG. 5 is a cross-sectional view illustrating the display along the spacers SPC. FIG. 5 shows three spacers on and along the scanning lines GL. This arrangement presents only one example, and number of spacers is not limited.

The inner space sealed by the rear panel PNL1, front panel PNL 2 and frame glass MFL is evacuated through the discharge nozzle PXC provided on a part of the rear panel PNL 1 to be kept at a given degree of vacuum.

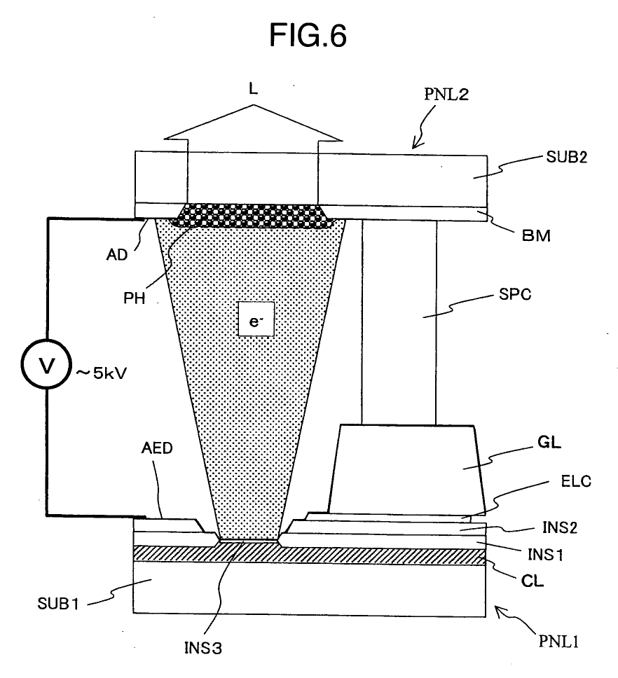

FIG. 6 schematically illustrates one example of pixel structure for the display of the present invention. The rear substrate SUB 1 supports, on the major plane (inside surface), the signal lines CL each serving as the lower electrode, for which an aluminum film is suitably used for the electron sources; first insulation film INS 1 composed of aluminum for the lower electrodes treated by anodic oxidation; second insulation film INS 2, for which a silicon nitride SiN film is suitably used; power supply electrodes (connection electrodes) ELC; scanning lines GL, for which chromium Cr is suitably used; and upper electrodes AED serving as the electron sources for pixels, connected to the scanning lines GL.

The electron source is composed of the signal line CL serving as the lower electrode which supports the thin film INS 3 as part of the insulation film INS 1 and upper electrode AED, in this order, where the upper electrode AED is formed in such a way to cover part of the scanning line GL and power supply electrode ELC. The thin film INS 3 is a so-called tunnel film. These members form a so-called diode electron source.

On the other hand, the front substrate SUB 2, for which a transparent glass substrate is suitably used, of the front panel PNL 2 supports, on the major plane, the fluorescent layers PH, each separated from the adjacent pixel by the black matrix BM, and positive electrodes AD, for which an aluminum film prepared by vacuum evaporation is suitably used. The rear panel PNL1 and front panel PNL 2 are spaced from each other by about 3 to 5 mm, the gap being kept by the spacers SPC.

In the above structure, applying an acceleration voltage (about 1 to 10 kV, about 5 kV specifically in FIG. 6) between the upper electrode AED for the rear panel PNL1 and positive electrode AD for the front panel PNL 2 emits the electrons e⁻, magnitude of which depends on display data size supplied to the signal line CL serving as the lower electrode. The electrons are accelerated by the acceleration voltage to hit the fluorescent layers PH, exciting them to emit the light L of given frequency to the outside of the front panel PNL 2. In the case of full-color display, the unit pixel serves as an auxiliary pixel (sub-pixel), and one color pixel is composed of 3 sub-pixels each being responsible for red (R), green (G) or blue (B) color.

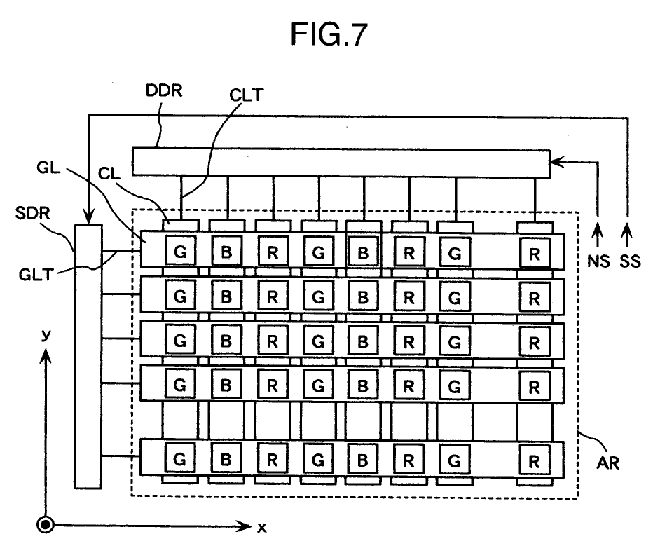

FIG. 7 illustrates one example of equivalent circuits for the display of the present invention. The area surrounded by the broken lines represents the display area AR, where the signal lines CL (n-lines) and scanning lines (m-lines) intersect with each other to form the n×m matrices. Each intersection constitutes a sub-pixel, and one color pixel is composed of 3 unit cells (sub-pixels), shown in the
figure, each being responsible for red (R), green (G) or blue (B) color. The signal lines CL are connected to the image signal driving circuit DDR at the terminals CLT, and the scanning lines GL are connected to the scanning signal driving circuit SDR at the terminals GLT. The image signal driving circuit DDR is supplied with the image signal NS from an outside signal source, and the scanning signal driving circuit SDR is similarly supplied with the scanning signal SS.

A two-dimensional, full-color image can be displayed by supplying an image signal to the signal lines CL intersecting with the scanning lines GL selected one by one. Use of the display panel of the above structure can realize a self-luminous, flat display working efficiently at a relatively low voltage.

Next, the spacer and its bonded structure are described. One embodiment of the spacer SPC described by referring to FIGS. 1 to 6 in the above examples is a formed shape of a glass containing SiO₂ as a main component and at least one element selected from the group consisting of La, Sc, Y, Ce, Pr, Nd, Pm, Sm, Eu, Gd, Tb, Dy, Ho, Er, Tm, Yb and Lu at 1 to 20% by mass. The spacer body is coated with an electric conductive film for antistatic purposes. The spacer body itself may be made of an electric conductive material instead of being coated with an electric conductive film.

The spacers SPC are arranged in the display area AR formed between the rear substrate SUB 1 and front substrate SUB 2 almost at right angles to these substrates, in such a way that they are lined up in parallel to each other in the length direction (x-direction in FIG. 7) at given intervals, and also in another direction (y-direction in FIG. 7) intersecting with the x-direction to run on the scanning lines GL at given intervals, and bonded by the electric conductive bonding material FGS (see FIG. 3). Next, embodiments of the bonding material of the present invention are described below.

### Example 1

Example 1 describes an example of preparing a V₂O₅-based glass as a base material for the electric conductive bonding material of the first aspect of the present invention. First, an electric conductive paste of V-based base material is prepared. It is necessary to select a proper base material in consideration of thermal expansion coefficient of a filler, e.g., of metal or electric conductive ceramic particles (electric conductive filler) to be incorporated to impart electroconductivity to the base material, in order to realize a target thermal expansion coefficient of the resulting composite. Example 1 describes melting of a glass base material for the paste.

The starting materials used are V₂O₅ (purity: 99.9%, Koujundo Chemical Laboratory), BaO (purity: 99.9%, Wako Pure Chemical), P₂O₅ (purity: 99.9%, Koujundo Chemical Laboratory) and Sb₂O₃ (purity: 99.9%, Koujundo Chemical Laboratory). The first step for preparation of a V-based base material is mixing of these starting materials to have a composition given in Table 1. A mixture of these materials except P₂O₅ is prepared beforehand to avoid exposure of P₂O₅ to air because of its high moisture-susceptibility. The mixed powder of these materials except P₂O₅ is placed on a scale together with an alumina crucible in which it is put, and a given amount of P₂O₅ is put in the crucible and mixed with the other starting materials with a metallic spoon. No mortar or ball mill is used for preparation of the mixture.

The mixed powder of the starting materials put in the alumina crucible is heated in a glass melting furnace at 5° C./minute to a given temperature level, 900 to 1000° C. selected for Example 1, at which it is held for 1 hour with stirring. The molten glass is then withdrawn from the furnace to be cast into a graphite mold, kept at 300° C. beforehand. The mold containing the glass is transferred into a strain-removing furnace kept at a desired temperature level beforehand, where it is kept at this temperature level for 1 hour to remove strain, and then cooled at 1° C./minute to room temperature. The resulting glass block is 30 by 40 by 80 mm in size. The glass compositions given in Table 1 were prepared by the above procedure.

The glass block was analyzed for surface resistivity, and then cut into a shape 4 by 4 by 15 mm in size for analysis of thermal expansion coefficient. The remainder was milled for DTA analysis.

The different compositions of the base material of V₂O₅-based glass were prepared in a similar manner. They had a thermal expansion coefficient which could be kept within a range from about 70×10⁻⁷ to 100×10⁻⁷/° C. (see Table 1).

TABLE 1
Base materials of V₂O₅-based glass, prepared in Example 1

| | | | | | | DTA characteristics | | | | | Properties of | | | | |
|---|---|---|---|---|---|---|---|---|---|---|---|---|---|---|---|
| Glass | | | | | Fusion | (up to 500° C.) | | | | | thermal expansion | | | Surface | |
| name | Composition by mass | | | | temperature | Tg | Mg | Ts | Tf | Tw | α | Tg | Mg | resistivity | |
| No. | V₂O₅ | BaO | P₂O₅ | Sb₂O₃ | (° C.) | (° C.) | (° C.) | (° C.) | (° C.) | (° C.) | (×10⁻⁷/° C.) | (° C.) | (° C.) | (Ω/□) | Remarks |
| VEC01 | 60 | 20 | 20 | | 900 | 305 | 335 | 380 | 435 | — | 103 | 310 | 338 | 4 × 10⁷ | |
| VEC02 | 64.6 | 22.8 | 12.6 | | 900 | 275 | 308 | — | — | — | 112 | 285 | 310 | 0.8 × 10⁷ | Crystallized |
| VEC03 | 64.9 | 18.2 | 16.9 | | 900 | 290 | 310 | — | — | — | 105 | 286 | 316 | 6 × 10⁷ | Crystallized |
| VEC04 | 65 | 5 | 25 | 5 | 1000 | 315 | 350 | 390 | 455 | — | 77 | 316 | 344 | 8 × 10⁷ | ◯ |
| VEC05 | 70 | | 25 | 5 | 1000 | 295 | 321 | 360 | 425 | 445 | 72 | 294 | 312 | 3 × 10⁷ | Crystallized |
| VEC06 | 65 | | 25 | 10 | 1000 | 315 | 340 | 380 | 440 | 490 | 73 | 313 | 327 | 3 × 10⁷ | ◯ |
| VEC07 | 65 | 5 | 25 | 5 | 1100 | 320 | 355 | 390 | 460 | — | 76 | 319 | 340 | 6 × 10⁷ | ◯ |
| VEC08 | 60 | 5 | 25 | 10 | 1000 | 335 | 355 | 405 | 465 | 525 | 76 | 333 | 351 | 1 × 10⁸ | Crystallized |

Tg: glass transition temperature (° C.)
Mg: Deformation temperature (° C.)
Ts: Softening Temperature
Tf: Flow Point
Tw: Working Temperature
α: Thermal Expansion coefficient (×10⁻⁷/° C.)

Surface resistivity is defined as follows according to JIS K6911.
Surface Resistivity (or Sheet Resistance):

$$\begin{matrix}ρ s ( Ω / □ ) = R ( Ω ) \times RCF \\ = ρ V \times ( 1 / t )\end{matrix}$$

R: resistance
RCF: resistivity correction factor
ρV: volumn resistivity (Ω·cm)
t: thickness of sample (cm)

It is essential to select a proper combination of base material and electric conductive filler, as done in Example 1, to realize a target electroconductivity and thermal expansion coefficient of the electric conductive frit. The following procedure may be used to realize a target thermal expansion coefficient by mixing a base glass material and filler.

A base glass material and filler are analyzed for thermal expansion coefficient (α), and mixed to have a volumetric composition using the following relation to produce a useful base glass material/filler mixture.
(Thermal expansion coefficient (α) of base material)×(base material volume/total volume)+(thermal expansion coefficient (α) of filler)×(filler volume/total volume)=Desired thermal expansion coefficient±10

An optimum bonding material can be prepared by determining a volumetric glass material/filler ratio and adjusting a filler shape and size.

### Example 2

Example 2 incorporated varying electric conductive particles in the base material of V₂O₅-based glass, prepared in Example 1, and analyzed properties of the resulting compositions as the electric conductive bonding materials, where VEC04 was selected as a representative base material composition.

Example 2 prepared the electric conductive bonding materials FGS which contained V₂O₅-based glass and fine particles of a metal selected from the group consisting of Pt, Pd, Cr, Ni, Al, Si, Zh, Au and Fe—Ni alloy, or of one or more species of electric conductive ceramics selected from the group consisting of TiC, SiC, WC, ZnO, Fe₂O₃, FeO, Fe₃O₄, AgV₇O₁₈ and Ag₂V₄O₁₁.

The content of the metallic or electric conductive ceramic particles was set at 1 to 40% by volume. It is particularly preferable to set the content at 10 to 40% by volume with the metallic particles, 10 to 40% by volume with the ceramic particles of TiC, SiC or WC, and at 10 to 30% by volume with the particles of ZnO, Fe₂O₃, FeO, Fe₃O₄, AgV₇O₁₈ or Ag₂V₄O₁₁ in consideration of electroconductivity and bonding characteristics.

VEC04 was selected from the V₂O₅-based glass compositions, prepared in Example 1, and incorporated with varying fine electric conductive particles to prepare the electric conductive bonding materials and analyze their properties.

Tables 2 and 3 describe the glass compositions, giving contents of metallic or electric conductive ceramic particles (mixing ratio, % by volume), and their electric resistivity (Ω·cm), thermal expansion coefficient (×10⁻⁷/° C.), softening temperature (° C.), flow diameter at 450° C. (mm) and adhesiveness to soda glass. Tables 2 and 3 give the similar contents, but divided for making them easily viewable. The flow diameter (mm) is defined as diameter of the formed powder shape, originally 10 mm in diameter and 50 mm high, after it is heated to 450° C. at which it is held for 30 minutes. It represents spread of the sample resulting from softening.

TABLE 2

| | Mixing ratio | | Thermal | | | |
|---|---|---|---|---|---|---|
| Electric | of the | Electric | expansion | Softening | Flow diameter | Adhesive |
| conductive | particles | resistivity | coefficient | temperature | at 450° C. | property to |
| particles | (% by volume) | (Ω · cm) | (×10⁻⁷/° C.) | (° C.) | (mm) | soda glass |
| None | 0 | 8.00 × 10⁸ | 67.0 | 325.0 | 16.3 | ◯ |
| Pt | 10 | 7.20 × 10⁸ | 79.9 | 328.2 | 15.2 | ◯ |
| Pt | 20 | 5.30 × 10⁸ | 87.6 | 331.4 | 14.3 | ◯ |
| Pt | 30 | 2.80 × 10⁴ | 101.0 | 334.6 | 11.8 | X |
| Pt | 40 | 1.60 × 10² | 102.5 | 337.8 | 10.5 | X |
| Pd | 10 | 8.64 × 10⁸ | 66.0 | 361.0 | 15.4 | ◯ |
| Pd | 20 | 6.36 × 10⁸ | 78.7 | 364.5 | 14.4 | ◯ |
| Pd | 30 | 3.36 × 10⁴ | 86.2 | 368.1 | 11.9 | ◯ |
| Pd | 40 | 1.92 × 10² | 99.5 | 371.6 | 10.6 | X |
| Cr | 10 | 6.84 × 10⁸ | 66.0 | 329.2 | 15.1 | ◯ |
| Cr | 20 | 5.04 × 10⁸ | 65.0 | 332.4 | 14.2 | ◯ |
| Cr | 30 | 2.66 × 10⁴ | 77.5 | 335.6 | 11.8 | ◯ |
| Cr | 40 | 1.52 × 10² | 85.0 | 338.8 | 10.5 | ◯ |
| Ni | 10 | 8.21 × 10⁸ | 81.1 | 362.0 | 15.3 | ◯ |
| Ni | 20 | 6.04 × 10⁸ | 88.9 | 365.5 | 14.4 | ◯ |
| Ni | 30 | 3.19 × 10⁴ | 102.6 | 369.1 | 11.9 | ◯ |
| Ni | 40 | 1.82 × 10² | 104.1 | 372.6 | 10.6 | ◯ |
| Al | 10 | 7.92 × 10⁸ | 77.1 | 311.8 | 15.4 | ◯ |
| Al | 20 | 5.83 × 10⁸ | 91.8 | 314.8 | 14.5 | ◯ |
| Al | 30 | 3.08 × 10⁴ | 100.7 | 317.9 | 11.9 | ◯ |
| Al | 40 | 1.76 × 10² | 116.2 | 320.9 | 10.6 | ◯ |
| Si | 10 | 9.50 × 10⁸ | 67.7 | 343.0 | 15.5 | ◯ |
| Si | 20 | 7.00 × 10⁸ | 80.6 | 346.3 | 14.6 | ◯ |
| Si | 30 | 3.70 × 10⁴ | 88.3 | 349.7 | 12.1 | ◯ |
| Si | 40 | 2.11 × 10² | 101.7 | 353.0 | 10.7 | ◯ |
| Zn | 10 | 7.52 × 10⁸ | 103.2 | 312.7 | 15.3 | ◯ |
| Zn | 20 | 5.54 × 10⁸ | 66.7 | 315.8 | 14.4 | ◯ |
| Zn | 30 | 2.93 × 10⁴ | 79.4 | 318.8 | 11.9 | ◯ |
| Zn | 40 | 1.67 × 10² | 86.9 | 321.9 | 10.6 | X |
| Au | 10 | 9.03 × 10⁸ | 100.2 | 343.9 | 15.5 | ◯ |
| Au | 20 | 6.65 × 10⁸ | 66.7 | 347.3 | 14.6 | ◯ |
| Au | 30 | 3.51 × 10⁴ | 65.7 | 350.6 | 12.0 | ◯ |
| Au | 40 | 2.01 × 10² | 78.2 | 354.0 | 10.7 | ◯ |
| Fe—50Ni Alloy | 10 | 1.81 × 10⁹ | 85.7 | 380.1 | 15.2 | ◯ |
| Fe—50Ni Alloy | 20 | 1.33 × 10⁹ | 81.8 | 383.8 | 14.3 | ◯ |
| Fe—50Ni Alloy | 30 | 7.02 × 10⁴ | 89.6 | 387.5 | 11.8 | ◯ |
| Fe—50Ni Alloy | 40 | 4.01 × 10² | 103.3 | 391.2 | 10.5 | X |

TABLE 3

| | Mixing ratio | | Thermal | | | |
|---|---|---|---|---|---|---|
| Electric | of the | Electric | expansion | Softening | Flow diameter | Adhesive |
| conductive | particles | resistivity | coefficient | temperature | at 450° C. | property to |
| particles | (% by volume) | (Ω · cm) | (×10⁻⁷/° C.) | (° C.) | (mm) | soda glass |
| None | 0 | 8.00 × 10⁸ | 67.00 | 325.00 | 16.30 | ◯ |
| TiC | 10 | 7.80 × 10⁷ | 74.03 | 327.38 | 15.32 | ◯ |
| TiC | 20 | 6.95 × 10⁷ | 81.17 | 330.57 | 14.41 | ◯ |
| TiC | 30 | 8.63 × 10⁶ | 93.66 | 333.76 | 11.89 | X |
| TiC | 40 | 4.98 × 10⁵ | 95.03 | 336.96 | 10.58 | X |
| ZnO | 5 | 7.80 × 10⁴ | 69.09 | 360.12 | 15.47 | ◯ |
| ZnO | 10 | 6.95 × 10⁴ | 75.75 | 363.63 | 14.56 | ◯ |
| ZnO | 15 | 8.63 × 10³ | 87.42 | 367.14 | 12.01 | X |
| ZnO | 20 | 4.98 × 10² | 88.69 | 370.65 | 10.69 | X |
| Fe2O3 | 5 | 1.56 × 10⁷ | 82.91 | 331.31 | 13.93 | ◯ |
| Fe2O3 | 10 | 1.39 × 10⁷ | 90.90 | 334.54 | 13.10 | ◯ |
| Fe2O3 | 15 | 1.73 × 10⁶ | 104.90 | 337.77 | 10.81 | X |
| Fe2O3 | 20 | 9.96 × 10⁴ | 106.43 | 341.00 | 9.62 | X |
| SiC | 10 | 9.36 × 10⁷ | 72.54 | 328.38 | 15.26 | ◯ |
| SiC | 20 | 8.34 × 10⁷ | 79.54 | 331.57 | 14.36 | ◯ |
| SiC | 30 | 1.04 × 10⁷ | 91.79 | 334.76 | 11.85 | ◯ |
| SiC | 40 | 5.98 × 10⁶ | 93.12 | 337.95 | 10.54 | X |
| wc | 10 | 1.12 × 10⁷ | 77.55 | 361.11 | 15.41 | ◯ |
| wc | 20 | 1.00 × 10⁷ | 85.03 | 364.63 | 14.50 | ◯ |
| wc | 30 | 1.24 × 10⁶ | 98.12 | 368.14 | 11.96 | ◯ |
| wc | 40 | 7.17 × 10⁵ | 99.55 | 371.65 | 10.65 | X |
| AgV7O18 | 5 | 9.00 × 10⁶ | 107.51 | 379.08 | 10.11 | ◯ |
| AgV7O18 | 10 | 8.40 × 10⁴ | 116.12 | 386.66 | 9.61 | ◯ |
| AgV7O18 | 20 | 3.20 × 10³ | 135.44 | 402.28 | 8.67 | ◯ |
| AgV7O18 | 30 | 3.40 × 10² | 157.97 | 418.54 | 7.83 | ◯ |
| AgV7O18 | 40 | 1.40 × 10² | 184.26 | 435.45 | 7.06 | X |
| Ag2V4O11 | 5 | 1.17 × 10⁷ | 139.77 | 492.81 | 13.15 | ◯ |
| Ag2V4O11 | 10 | 1.09 × 10⁵ | 150.95 | 502.66 | 12.49 | ◯ |
| Ag2V4O11 | 20 | 4.16 × 10³ | 176.07 | 522.97 | 11.27 | ◯ |
| Ag2V4O11 | 30 | 4.42 × 10² | 205.37 | 544.10 | 10.17 | ◯ |
| Ag2V4O11 | 40 | 1.82 × 10² | 239.54 | 566.08 | 9.18 | ◯ |

### Example 3

Example 3 describes the electric conductive bonding material as the second aspect of the present invention. The electric conductive bonding material FGS prepared in Example 3 contained V₂O₅ at 55 to 75%, P₂O₅ at 15 to 30%, BaO at 0 to 25%, Sb₂O₃ at 0 to 15% (total content of BaO and Sb₂O₃ adjusted at 5% or more) and GeO₂ at 5 to 20%, all percentages by mass.

The electric conductive bonding material FGS prepared in Example 3 may contain V₂O₅ at 55 to 75%, P₂O₅ at 15 to 30%, BaO at 0 to 25%, Sb₂O₃ at 0 to 15% (total content of BaO and Sb₂O₃ adjusted at 5% or more) and Ag₂O at 3 to 10%, all percentages by mass.

Moreover, the electric conductive bonding material FGS may be incorporated with a ceramic filler of low thermal expansion coefficient, selected from the group consisting of SiO₂, ZrO₂, Al₂O₃, ZrSiO₄, zirconium phosphate (ZWP), cordierite, mullite and eucryptite fillers.

The present invention can provide a display which can produce high-quality images by arranging spacers between its rear and front substrates using the electric conductive bonding material prepared in Example 3, because electric charges can be absorbed by the substrates to protect the spacers from increased charges.

An example of preparing an electric conductive V₂O₅-based glass is described.

The starting materials used are V₂O₅ (purity: 99.9%, Koujundo Chemical Laboratory), BaO (purity: 99.9%, Wako Pure Chemical), P₂O₅ (purity: 99.9%, Koujundo Chemical Laboratory), Sb₂O₃ (purity: 99.9%, Koujundo Chemical Laboratory), GeO₂ (purity: 99.9%, Koujundo Chemical Laboratory) and Ag₂O (purity: 99.9%, Koujundo Chemical Laboratory). The first step for preparation of a V-based base material is mixing of these starting materials to have a composition given in Table 4. A mixture of these materials except P₂O₅ is prepared beforehand to avoid exposure of P₂O₅ to air because of its high moisture-susceptibility. The mixed powder of these materials except P₂O₅ is placed on a scale together with an alumina crucible in which it is put, and a given amount of P₂O₅ is put in the crucible and mixed with the other starting materials with a metallic spoon. No mortar or ball mill is used for preparation of the mixture.

The mixed powder of the starting materials put in the alumina crucible is heated in a glass melting furnace at 5° C./minute to a given temperature level, 900 to 1200° C. selected for Example 3, at which it is held for 1 hour. Increasing melting (preparation) temperature to 1200° C. is to increase production of V⁴⁺ and, at the same time, to have a firmer glass skeleton.

The molten glass is stirred for 1 hour at the above temperature level, and then withdrawn from the furnace to be cast into a graphite mold, kept at 300° C. beforehand. The mold containing the glass is transferred into a strain-removing furnace kept at a desired temperature level beforehand, where it is kept at this temperature level for 1 hour to remove strain, and then cooled at 1° C./minute to room temperature. The resulting glass block is 30 by 40 by 80 mm in size. The glass compositions given in Table 4 were prepared by the above procedure.

The glass block was analyzed for surface resistance, and then cut into a shape 4 by 4 by 15 mm in size for analysis of thermal expansion coefficient. The remainder was milled for DTA analysis.

Example 3 demonstrates that adjusting a glass composition and melting temperature can realize an electroresistivity of the glass composition of the order of 10⁵ to 10⁷ Ω·cm, as shown in Table 4. Incorporation of Ag₂O brings an effect of reducing electroresistivity of the V-based glass, and incorporation of GeO₂ brings an effect of improving heat resistance of the glass without deteriorating its electroresistivity characteristics. It is possible to control thermal expansion coefficient of the glass composition within a range from about 50×10⁻⁷ to 80×10⁻⁷/° C. by incorporating a filler of low thermal expansion, e.g., zirconium phosphate.

The electric conductive bonding material of the present invention, prepared in Example 3, is characterized by that it in itself is provided with adequate electroconductivity, thermal expansion and temperature characteristics. A filler to be incorporated to finely adjust thermal expansion coefficient of the electric conductive bonding material of the present invention is not required to be electric conductive in itself. Therefore, it may be selected from widely varying ceramic materials of low thermal expansion coefficient. Compounds other than Ag₂O and GeO₂, which are used in Example 3, may be used to control electroconductivity and heat resistance characteristics of the glass composition.

TABLE 4

| Glass | | | | | | | Fusion | Properties of thermal | | | Electric |
|---|---|---|---|---|---|---|---|---|---|---|---|
| name | Composition (% by mass) | | | | | | temperature | expansion | | | resistivity |
| No. | V₂O₅ | BaO | P₂O₅ | Sb₂O₃ | Ge2O | Ag2O | (° C.) | α (×10⁻⁷/° C.) | T_{g}(° C.) | M_{g}(° C.) | (×10⁻⁷ Ωcm) |
| V-based | 55 | 15 | 15 | 5 | 10 | | 1100 | 78 | 381 | 404 | 4.5 |
| glass 1 | | | | | | | | | | | |
| V-based | 55 | 10 | 10 | 5 | 20 | | 1100 | 79 | 408 | 443 | 2.7 |
| glass 2 | | | | | | | | | | | |
| V-based | 60 | 5 | 20 | 5 | | 10 | 1000 | 82 | 319 | 345 | 0.09 |
| glass 3 | | | | | | | | | | | |
| V-based | 60 | 5 | 25 | 5 | | 5 | 1000 | 81 | 314 | 337 | 0.4 |
| glass 4 | | | | | | | | | | | |
| V-based | 65 | 10 | 10 | 5 | 10 | | 1100 | 81 | 400 | 423 | 8.9 |
| glass 5 | | | | | | | | | | | |
| V-based | 65 | 10 | 10 | 5 | | 10 | 1000 | 85 | 314 | 325 | 0.03 |
| glass 6 | | | | | | | | | | | |
| V-based | 70 | 5 | 15 | 5 | 5 | | 900 | 83 | 389 | 412 | 10.4 |
| glass 7 | | | | | | | | | | | |
| V-based | 70 | 5 | 15 | 5 | | 5 | 900 | 87 | 320 | 348 | 0.8 |
| glass 8 | | | | | | | | | | | |
| V-based | 75 | 5 | 10 | 5 | 5 | | 900 | 86 | 376 | 395 | 11.2 |
| glass 9 | | | | | | | | | | | |
| V-based | 75 | 5 | 10 | 5 | | 5 | 900 | 88 | 315 | 330 | 0.7 |
| glass 10 | | | | | | | | | | | |

Tg: glass transition temperature (° C.)
Mg: Deformation temperature (° C.)
α: Thermal Expansion coefficient (×10⁻⁷/° C.)

It should be further understood by those skilled in the art that although the foregoing description has been made on embodiments of the invention, the invention is not limited thereto and various changes and modifications may be made without departing from the spirit of the invention and the scope of the appended claims.

### ADVANTAGE OF THE INVENTION

The present invention can provide a display device which can produce high-quality images, because the electric conductive bonding material of the present invention secures spacers to a rear and front substrates of the display to absorb electric charges by the substrates, protecting the spacers from increased charges.

The electric conductive bonding material can provide current passages uniformly and stably. It can find use as a wiring material, and satisfies the RoHS regulations, because it is free of lead (Pb).

1. An electric conductive bonding material comprising:
a V₂O₅-based glass as a main component, and
particles of a metal; selected from the group consisting of Pt, Pd, Cr, Ni, Al, Si, Zn, Au and Fe—Ni alloy, or particles of one or more species of electric conductive ceramics.

2. The electric conductive bonding material according to claim 1, wherein the electric conductive ceramic is selected from the group consisting of TiC, SiC, WC, ZnO, Fe₂O₃, FeO, Fe₃O₄, AgV₇O₁₈ and Ag₂V₄O₁₁.

3. The electric conductive bonding material according to claim 1, wherein the metal or electric conductive ceramic particles are incorporated at 1 to 40% by volume.

4. The electric conductive bonding material according to claim 1, wherein the V₂O₅-based glass contains V₂O₅ at 30 to 70%, P₂O₅ at 10 to 60%, BaO at 5 to 30% and Sb₂O₃ at 5 to 30%, all percentages by mass, and has a softening temperature of 250 to 360° C.

5. An electric conductive bonding material comprising:
V₂O₅ at 55 to 75%, P₂O₅ at 15 to 30%, BaO at 0 to 25% and Sb₂O₃ at 0 to 15% (wherein total content of BaO and Sb₂O₃ are 5% or more); and
GeO₂ at 5 to 20% or Ag₂O at 3 to 10%,
all percentages by mass as oxide.

6. The electric conductive bonding material according to claim 5, further incorporating a ceramic filler at 5 to 30% by volume.

7. The electric conductive bonding material according to claim 6, wherein the ceramic filler is selected from the group consisting of SiO₂, ZrO₂, Al₂O₃, ZrSiO₄, zirconium phosphate (ZWP), cordierite, mullite and eucryptite.

8. A display device comprising a rear panel, front panel, spacers, and frame glass,
wherein the rear panel has a rear substrate which supports a display region composed of: a number of signal lines running in parallel to each other in a first direction; a number of scanning lines, insulated from the signal lines and running in parallel to each other in a second direction intersecting with the first direction; and a number of pixels having electron sources located at near intersections of the signal lines and the scanning lines,
the front panel has a front substrate which supports positive electrodes and fluorescent layers each being excited by electrons from the electron sources to emit a different color,
the spacers are bonded between the rear panel and the front panel in the display region with the aid of an electric conductive bonding material to keep a prescribed gap between the rear panel and the front panel, and
the frame glass is secured to the rear panel and the front panel along inner circumferential edges via a sealant to keep a space between them air-tight, wherein
the electric conductive bonding material is the one according to claim 1.

9. A display device comprising a rear panel, front panel, spacers, and frame glass,
wherein the rear panel has a rear substrate which supports a display region composed of: a number of signal lines running in parallel to each other in a first direction; a number of scanning lines, insulated from the signal lines and running in parallel to each other in a second direction intersecting with the first direction; and a number of pixels having electron sources located at near intersections of the signal lines and the scanning lines,
the front panel has a front substrate which supports positive electrodes and fluorescent layers each being excited by electrons from the electron sources to emit a different color,
the spacers are bonded between the rear panel and the front panel in the display region with the aid of an electric conductive bonding material to keep a prescribed gap between the rear panel and the front panel, and
the frame glass is secured to the rear panel and the front panel along inner circumferential edges via a sealant to keep a space between them air-tight, wherein
the electric conductive bonding material is the one according to claim 5.

10. The display device according to claim 8, wherein the spacer comprises a molding of a glass material containing SiO₂ as a main component and at least one element selected from the group consisting of La, Sc, Y, Ce, Pr, Nd, Pm, Sm, Eu, Gd, Tb, Dy, Ho, Er, Tm, Yb and Lu at 1 to 20% by mass.

11. The display device according to claim 9, wherein the spacer comprises a molding of a glass material containing SiO₂ as a main component and at least one element selected from the group consisting of La, Sc, Y, Ce, Pr, Nd, Pm, Sm, Eu, Gd, Tb, Dy, Ho, Er, Tm, Yb and Lu at 1 to 20% by mass.
